(19) United States
(12) Patent Application Publication
(10) Pub. No.: US 2007/0211493 A1
(43) Pub. Date: Sep. 13, 2007

(54) Light guide plate with auxiliary light guide structures

(75) Inventors: Chong-Yang Fang, Tainan County (TW); Ping-Yeng Chen, Taichung County (TW); Kuo-Jui Huang, Taichung County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/367,592

(22) Filed: Mar. 6, 2006

(51) Int. Cl. F21V 7/04

(52) U.S. Cl. 362/616

(57) ABSTRACT

A light guide plate (LGP) with auxiliary light guide structures is presented, wherein the top or bottom surface has a plurality of auxiliary light guide structures and light guide patterns, and wherein the dihedral angle between the tangent plane of the auxiliary light guide structure and the reference plane is less than 40 degrees. And the surfaces of the light guide pattern are rough surfaces. Together with the functions of the auxiliary light guide structures and the light guide patterns, the light is guided and emitted out of the LGP, and then the probability of the light emitted out of the LGP is increased after the light is scattered or reflected by the light guide patterns.

### FIELD OF THE INVENTION

The present invention relates to a light guide plate (LGP) technology of the backlight module, wherein the light guide structures and the auxiliary light guide structures are collocated on the top or bottom surface to enhance the light efficiency of the LGP.

### BACKGROUND OF THE INVENTION

The conventional light guide plate (LGP) is established with scattering-type structures or reflecting-type structures on its top or bottom surface to guide the incident light to leave the light guide plate. Beyond scattering structures or reflecting structures established on a surface of LGP, other parts of the surface are smooth. The light emitted to the smooth surface is guided to the end of LGP far from the light source, so that the light uniformity of the LGP is enhanced.

FIG. 1 PRIOR ART shows the conventional scattering-type LGP 9. The bottom surface 8 of the LGP 9 has the irregular rough surface 81 made by the etching method, which makes the incident light A from the light source scatter, and a part of the scattering lights a1, a2 are emitted out of the top surface 91 of the LGP 9.

However, beyond the rough surface 81 established on the bottom surface 8 of the LGP 9, other parts of the bottom surface 8 are smooth planes 82. If the incident angle of the light A′ is larger than the total internal reflection angle, the smooth plane 82 will reflect the light A′. And this kind of light is not easy to form an emitting light. Contrarily the light is reflected from the top surface 91 to form a reflecting light B, so that the light A′ can be guided to the end of the LGP 9. Although this kind of structure is helpful to guiding light to the end of LGP 9, the reflecting light coming from the smooth plane 82 of the bottom surface 8 has a large incident angle 1 when it arrives on the top surface 91. The light with this angle becomes scattering when the light arrives at the rough surface 81 that is more near to the end of LGP 9. Only a part of the scattering light can form emitting lights a1, a2 that are emitted out of the top surface 91, thereby the light efficiency of the LGP is insufficient.

Furthermore, for the conventional LGP with the reflecting-type structures, beyond the reflecting structures established on a surface of LGP, other parts of the surface are smooth. Therefore, the light efficiency is insufficient as well, and that is to be improved.

### SUMMARY OF THE INVENTION

In order to solve the above problems, the purpose of the invention is to present a kind of LGP with auxiliary light guide structures. By using a plurality of auxiliary light guide structures and a plurality of light guide structures arrayed on the top and bottom surfaces of the LGP, a light can be guided to trend to the normal direction of the illuminant surface of the LGP. Therefore, more lights can break the total internal reflection limit of the LGP and be emitted out of the LGP, and then the light efficiency is increased and the backlight brightness of LCD is enhanced also.

To achieve the purpose, the LGP in the invention has one light input surface, one top surface, and one bottom surface. The top surface is on one side of the light input surface, and the bottom surface is opposite to the top surface. Besides, the top or bottom surface is defined as a reference plane and has the following structures for a basis auxiliary light guide structure and light guide pattern. Each auxiliary light guide structure has an auxiliary light guide surface, and the dihedral angle between the tangent plane of the auxiliary light guide surface and the reference plane is less than 40 degrees. Each of the light guide patterns is surrounded by the auxiliary light guide structures. Together with the functions of the auxiliary light guide structures and the light guide patterns, light is guided and emitted out of the LGP.

### BRIEF DESCRIPTION OF THE DRAWINGS

FIG. 1 PRIOR ART shows the schematic diagram of the conventional LGP structure.

FIG. 2 shows the schematic diagram of the LGP structure of the invention.

FIG. 3 shows the bottom-view of the LGP of the invention.

FIG. 4 shows the schematic diagram of the light path of the LGP of the invention.

FIG. 5 shows the simulating brightness distribution map of the ends of LGPs of the invention and the conventional. (Luminance distribution of the source is in the range of 0 to 20 degrees)

FIG. 6 shows the simulating brightness distribution map of the ends of LGPs of the invention and the conventional. (Luminance distribution of the source is in the range of 20 to 40 degrees)

FIG. 7 shows the bottom-view of the LGP of the second embodiment of the invention.

FIG. 8 shows the schematic diagram of the LGP of the third embodiment of the invention.

FIG. 9 shows the schematic diagram of the rough surface of the second light guide structure of the third embodiment.

FIG. 10 shows the schematic diagram of the arc concave structures of the second light guide structure of the third embodiment.

FIG. 11 shows the schematic diagram of the pyramid-like structures of the second light guide structure of the third embodiment.

FIG. 12 shows the schematic diagram of the prism-like structures of the second light guide structure of the third embodiment.

FIG. 13 shows the schematic diagram of the cone-like structures of the second light guide structure of the third embodiment.

FIG. 14 shows the schematic diagram of the cylinder-like structures of the second light guide structure of the third embodiment.

FIG. 15 shows the schematic diagram of the V groove-like auxiliary light guide structures.

FIG. 16 shows the schematic diagram of the arc cylinder-like auxiliary light guide structures.

FIG. 17 shows the schematic diagram of the pyramid-like auxiliary light guide structures.

FIG. 18 shows the schematic diagram of the prism-like auxiliary light guide structures.

FIG. 19 shows the schematic diagram of the cone-like auxiliary light guide structures.

### DESCRIPTION OF THE PREFERRED EMBODIMENTS

The detail contents and illustrations of the technologies of the invention are given below.

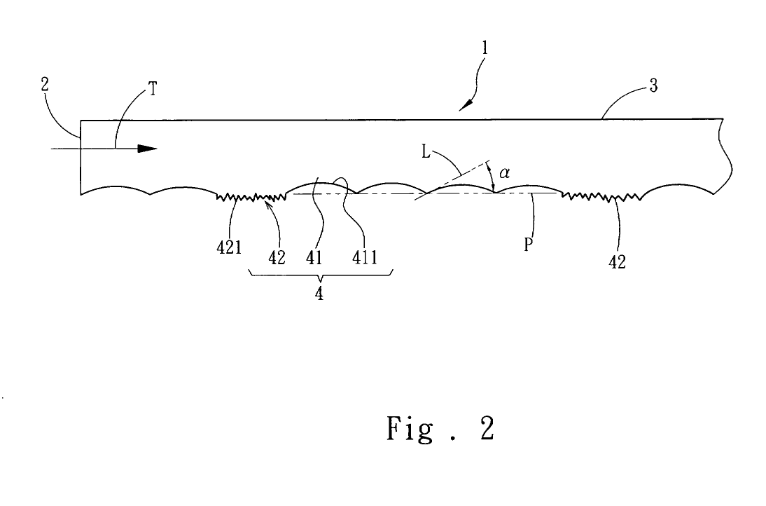

The structures in FIGS. 2 through 4 are examples for demonstration, but are not limit for the patent application.

The auxiliary light guide structures of LGP in this invention can be established on the top or bottom surface. The auxiliary light guide structures in the first embodiment of the invention are established on the bottom surface. The structures are described in detail as follows:

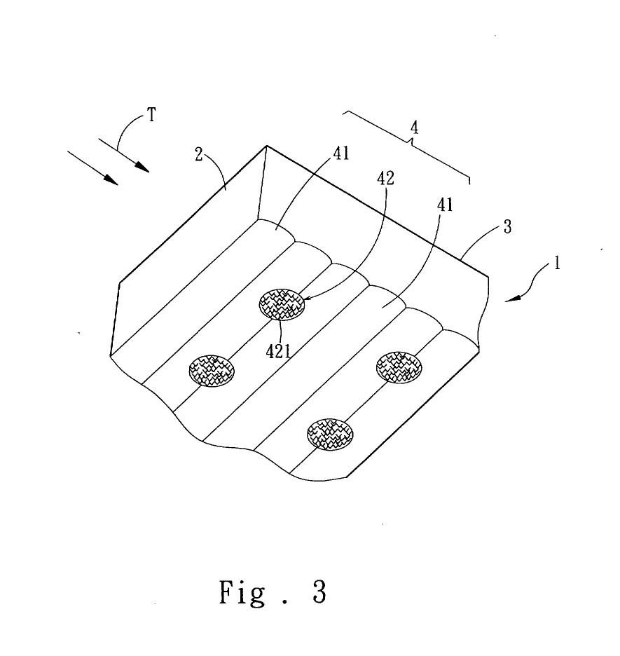

The LGP 1 in the first embodiment of the invention has a light input surface 2. The top surface 3 is on one side of the light input surface 2, and the bottom surface 4 is opposite to the top surface 3. The bottom surface 4 is defined as a reference plane P, and its configuration is a plurality of auxiliary light guide structures 41. The arrangement of the a plurality of auxiliary light guide structures 41 parallels the light input direction T of the light of LGP 1 (i.e. each auxiliary light guide structure 41 itself parallels the light input surface 2, as shown in FIG. 3), and each of the auxiliary light guide structures 41 has an auxiliary light guide surface 411. The auxiliary light guide structures are at least one kind of structure such as arc concave, V-groove structure, arc-trench structure, pyramid-like structure prism-like structure, or cone-like structure. The auxiliary light guide surface 411 in this embodiment is an arc-concave-cylinder-like structure, and the dihedral angle between the tangent plane L of the auxiliary light guide surface 411 and the reference plane P is less than 40 degrees.

Each of the light guide patterns 42 is surrounded by the auxiliary light guide structures 41 on the bottom surface 4 and has a plurality of fine structures 421. The surface of light guide patterns 42 is one kind of structures below: rough surface, V-groove, arc-trench, pyramid-like structure, prism-like structure, cone-like structure, or cylinder-like structure. The light guide patterns 42 in this embodiment are rough surface made by an etching method. Together with the functions of the auxiliary light guide structures 41 and the light guide patterns 42, light is guided and emitted out of the LGP 1.

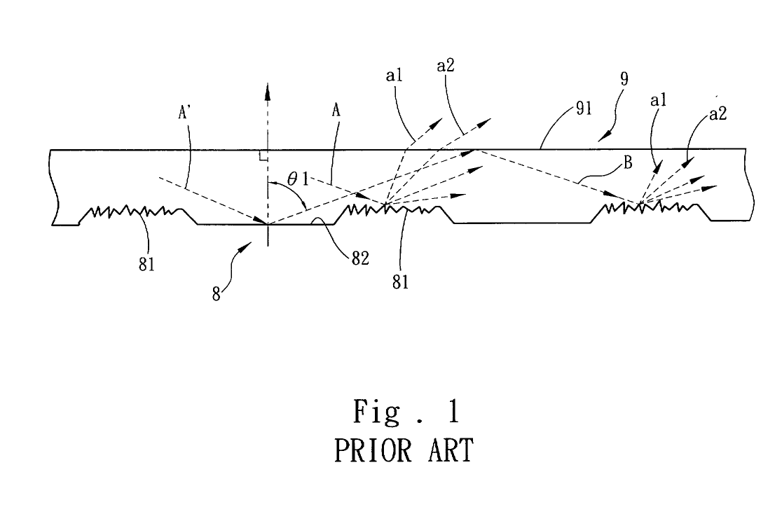

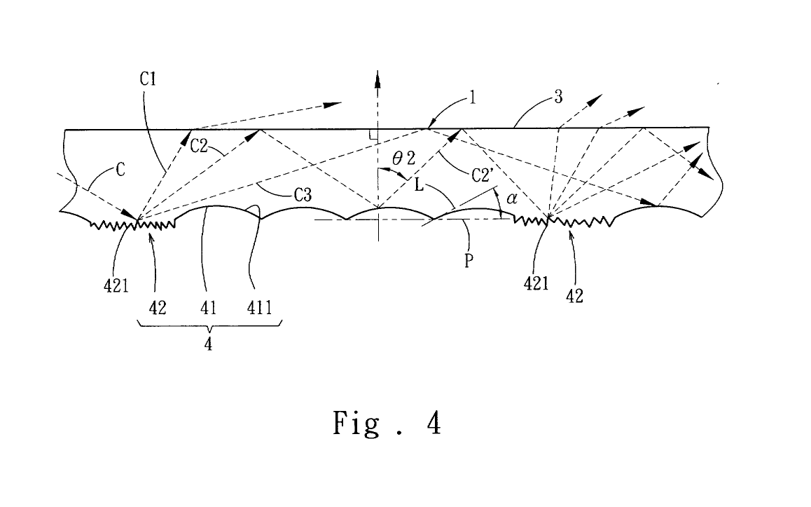

FIG. 4 indicates that the light scatters, when the incident light C is emitted into the light guide pattern 42. Only a part of light (light C1) has the incident angle that is smaller than the total internal reflection angle and can output the LGP 1 when it meets the top surface 3. The other part of scattering light (C2 or C3) is transmitted in the LGP 1 due to the larger incident angle with respect to the normal direction of the top surface 3. When the scattering light C2 is reflected to the auxiliary light guide structures 41, the incident angle 0.2 is smaller (compared with 0.1 formed by the previous technology shown in FIG. 1) due to the dihedral angle . between the tangent plane L of the auxiliary light guide structures 41 and the LGP 1. Therefore, the probability of the scattering lights emitted out of the LGP 1 by the guide light patterns 42 is increased as the reflecting light C2′ incident on the light guide patterns 42 again. That is to say, the light utility rate of the LGP 1 is enhanced.

Of course, the direction of the reflecting light C2′ can be controlled in the invention by adjusting the dihedral angle between the tangent plane L of the auxiliary light guide surfaces 411 of the auxiliary light guided structures 41 and the reference plane P, as shown in FIG. 4. When the angle is less than 20 degrees, the reflecting light C2′ is reflected easily by the top surface 3 and is guided to the end of the LGP 1 due to the larger incident angle.2. When the angle . is between 20 and 40 degrees, the reflecting light C2′ is emitted out of the top surface 3 easily since the reflecting light C2′ is near the normal direction of the illuminant surface of the LGP 1. Thereby, the brightness of the LGP 1 is enhanced.

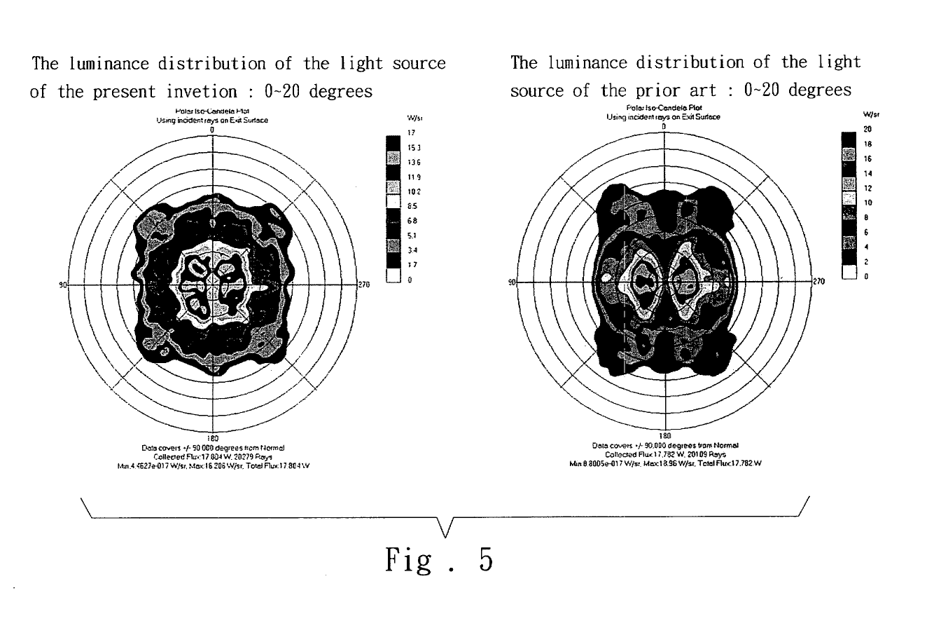

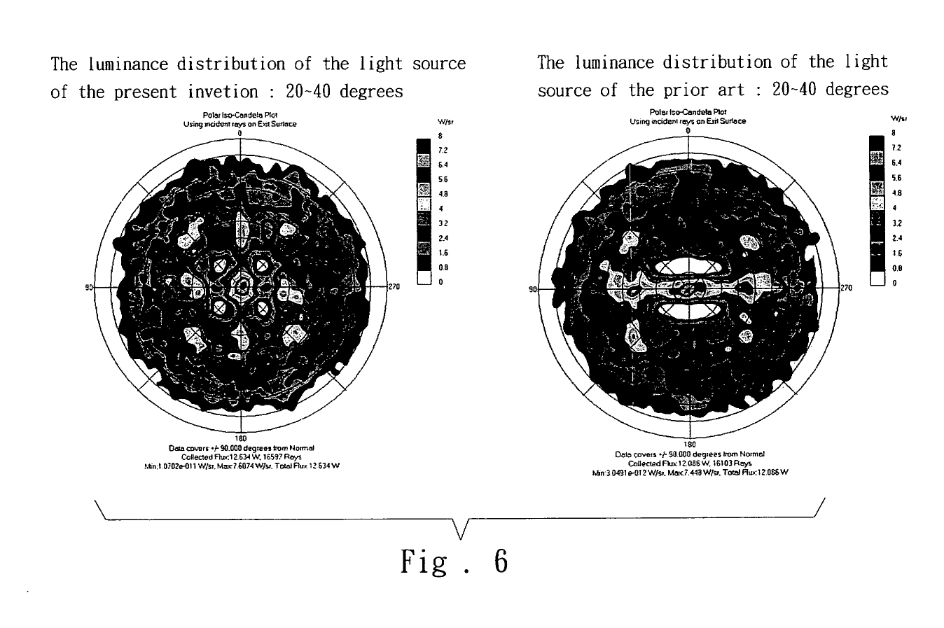

FIGS. 5 and 6 show the brightness distribution map of the LPG's end of the invention and the previous technology, respectively, by using simulation software Tracepro. The simulation conditions are given as follows:

a. If the normal direction of the light emitted surface of the light source is defined as 0 degree axis, the luminance distribution of light source is in the first angle range between 0 and 20 degrees (as shown in FIG. 5) and second angle range between 20 and 40 degrees (as shown in FIG. 6), respectively.

b. The light detector is located 0.01 mm away from the end of LGP 1, and the normal direction of the light detector is parallel to the normal direction of the illuminant surface of the LGP's end.

c. The amount of the light traces is 200,000.

d. The 0 degree azimuth direction of the detector is parallel to the normal direction of the illuminant surface of LGP 1, and the 0 degree elevation direction of the detector is parallel to the normal direction of the illuminant surface of light source.

According to the simulation results, the brightness distribution of the LGP 1 in the invention is compared with that of the conventional LGP, as shown in FIGS. 5 and 6. The brightness distribution at 90 degrees of azimuth is shifted to the direction of 0 or 180 degrees of azimuth, i.e. the amount of light that is close to the normal direction of the illuminant surface of LGP 1 is more. Therefore, the amount of light emitted out of the LGP 1 is increased also.

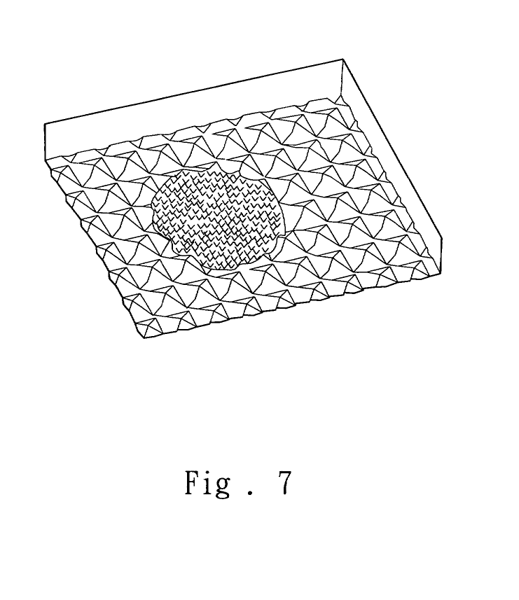

In the same way, if these auxiliary light guide structures 41 are arranged in both directions that cross each other, as shown in FIG. 7, thus the second embodiment of the invention has the same effect as the previous embodiment. Furthermore, if the auxiliary light guide structures 41 are arranged in the actinoid directions based on the light source center of the LGP 1, the same effect can be achieved.

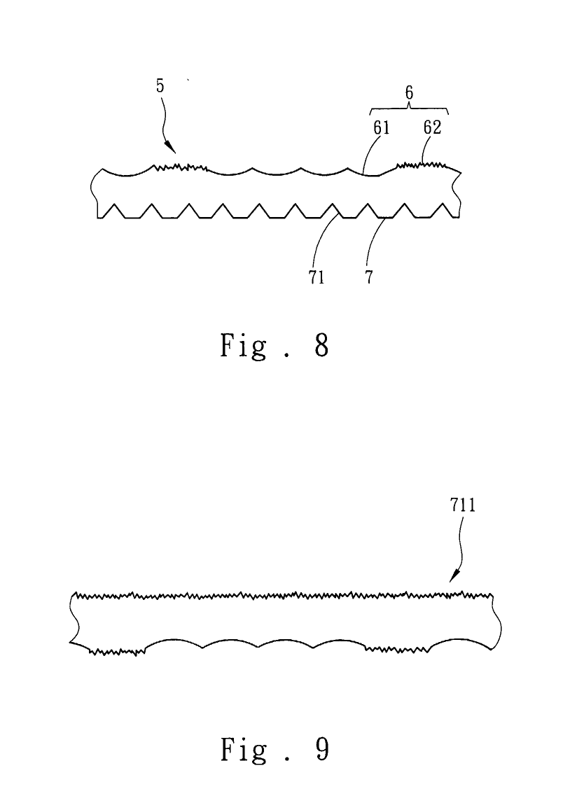

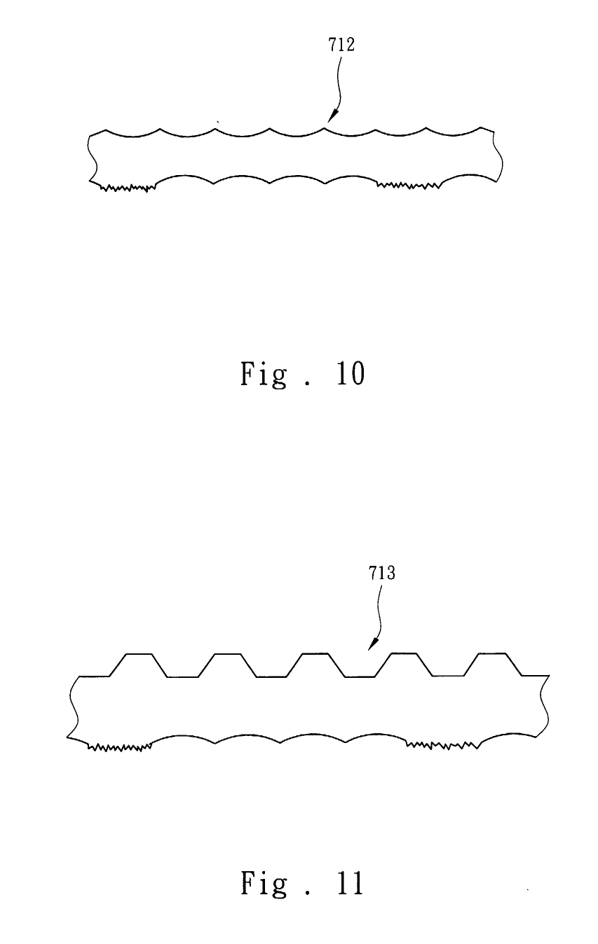

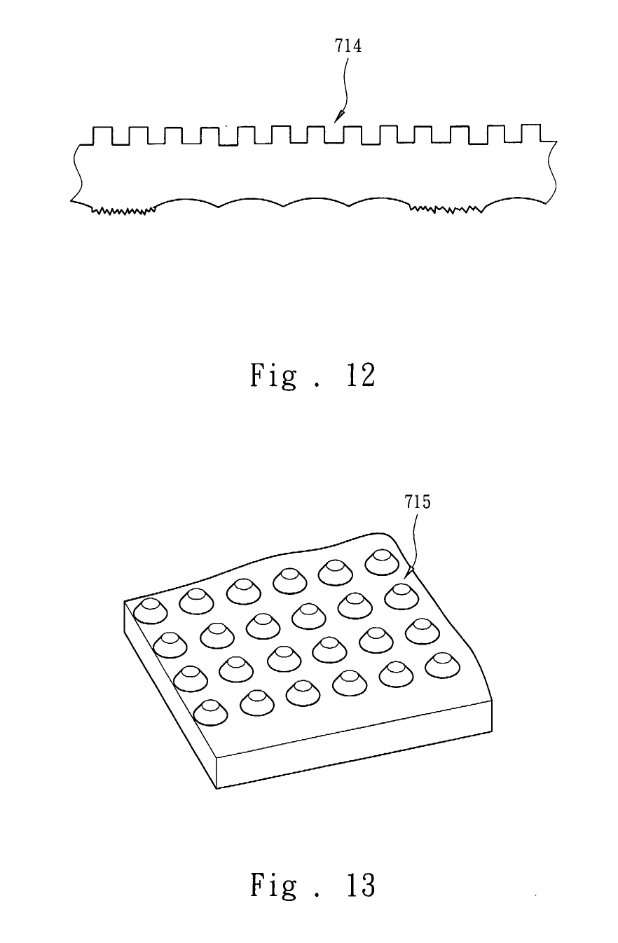

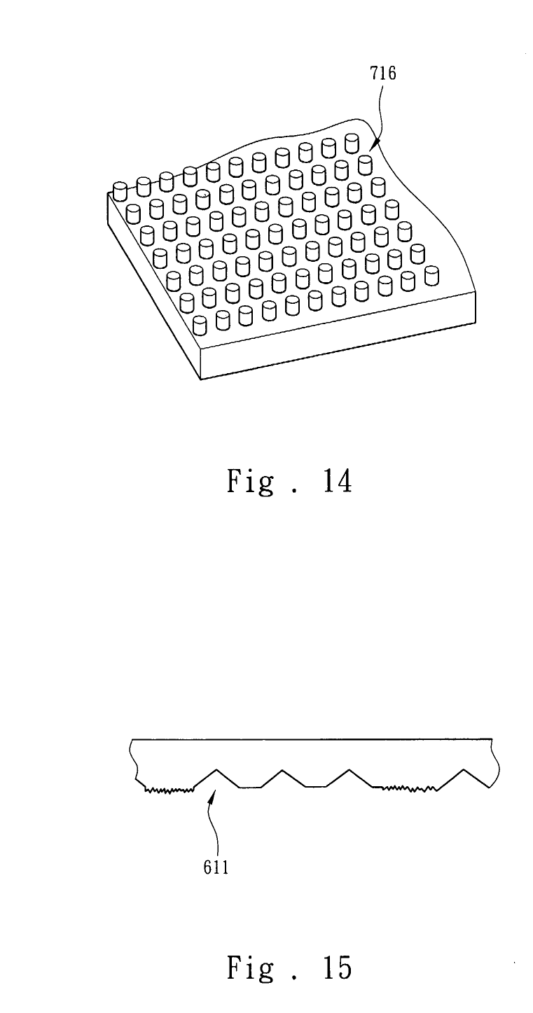

Besides, FIG. 8 shows the third embodiment of the invention, wherein a plurality of auxiliary light guide structures 61 and a plurality of light guide patterns 62 are established on the top surface 6 of the LGP 5, and the second light guide patterns 71 with conventional structure are established on the bottom surface 7. Instead of the V-grooves are indented on the bottom surface 7, which are presented as an example in this embodiment, other structures can be used, for example, rough surface structures 711 (FIG. 9), multi-arc concave structures 712 (as shown in FIG. 10), pyramid-like structures 713 (as shown in the FIG. 11), prism-like structures 714 (FIG. 12), cone-like structures 715 (FIG. 13), or cylinder-like structures 716 (FIG. 14). Certainly, two of the above structures can be combined together as the second light guide patterns 71, such as the multi-arc concave structures 712 can be coexistent with the pyramid-like structures 713, or the cone-like structures 715 is coexistent with the cylinder-like structures 716.

With the help of the auxiliary light guide structures 61 and the light guide patterns 62 on the top surface 6, the light is guided to the direction that has smaller included angle with the normal direction of the top surface 6. In addition, cooperating the second light guide patterns 71 on the bottom surface 7, the light is guided to the direction which has smaller included angle with the normal direction of the top surface 6, and this makes the light be emitted out of the LGP 1 to enhance the light utility rate.

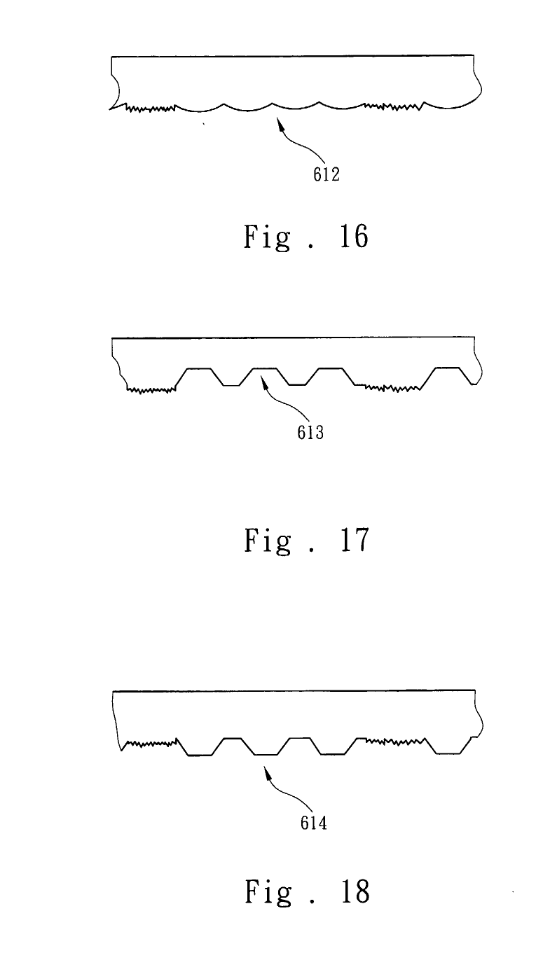

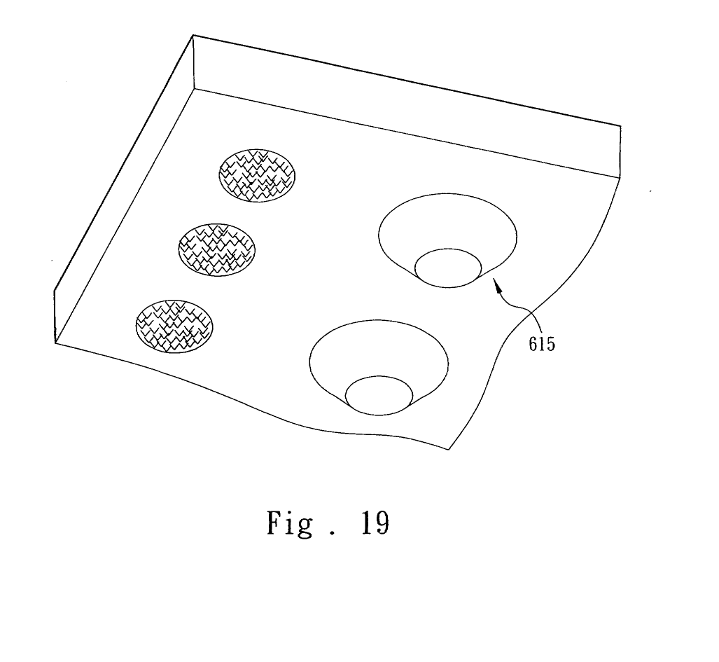

Besides the previous auxiliary light guide structures 41, other structures can be used, for example, V-groove structures 611 (FIG. 15), arc-groove structures 612 (as shown in FIG. 16), pyramid-like structures 613 (as shown in FIG. 17), prism-like structures 614 (as shown in FIG. 18), or cone-like structures 615 (as shown in FIG. 19). Certainly, two of the above auxiliary structures can be combined together, for embodiment, the V-groove structures 611 can be coexistent with the arc-groove structures 612, or the pyramid-like structures 613 is coexistent with the cone-like structures 615.

When one kind of the auxiliary light guide structures 61, including the V-groove structures 611 (as shown in FIG. 15), pyramid-like structures 613 (FIG. 17), or prism-like structures 614 (FIG. 18), is used, the dihedral angle between the auxiliary light guide surface 411 of the auxiliary light guide structure 41 and the reference plane is less than 40 degrees. When the arc-groove structures 612 (FIG. 16) are used, the dihedral angle between the tangent plane of the arc-groove and the reference plane is less than 40 degrees. When the cone-like structures 615 (FIG. 19) are used, the included angle between the conic surface of the auxiliary light guide structure and the reference plane is less than 40 degrees. Various kinds of the structures of the auxiliary light guide structures in this section are equivalent to the cylinder-like structure in the previous first embodiment and can achieve the same effect as the previous first embodiment does. Furthermore, the surface of the auxiliary light guide structures can be smooth or rough surface, and any one of them can enhance the light utility rate.

To sum up, the main features of the invention are that one of the LGP surfaces forms non-planar auxiliary light guide structures, and the auxiliary light guide structures and the light guide patterns are arranged on the same surface. Therefore, the included angle between the reflecting light of the auxiliary light guide structures and the normal direction of the light illuminant surface of the LGP is reduced, and thus the probability of the light emitted out of the LGP is increased to enhance the light utility rate as the light is scattered or reflected by the light guide patterns.

The above embodiments are to reveal the clarification in the invention, but not to constrain the invention. Therefore, all the variations of the values and the replacement of the equivalent elements are included in what is claimed in this invention.

While the above mentions are some better examples for demonstration but not the limitation of application in this invention. All the homogeneous modification and variations of the invention are included in what is claimed in this invention.

What is claimed is:

1. A light guide plate with auxiliary light guide structures, the light guide plate having a light input surface, a top surface on one side of the light input surface, and a bottom surface opposite to the top surface, wherein at least one of the top surface and the bottom surface comprises.
a plurality of auxiliary light guide structures, each of the auxiliary light guide structures having a auxiliary light guide surface, a dihedral angle between a tangent plane of the auxiliary light guide surface and a reference plane being less than 40 degrees, and;
a plurality of light guide patterns, each of the light guide patterns being surrounded by the auxiliary light guide structures.

2. The light guide plate of claim 1, wherein the reference plane is parallel to the top surface with the auxiliary light guide structures thereon.

3. The light guide plate of claim 1, wherein the reference plane is parallel to the bottom surface with the auxiliary light guide structures thereon.

4. The light guide plate of claim 1, wherein each of the light guide patterns has a plurality of fine structures.

5. The light guide plate of claim 1, wherein the auxiliary light guide structures are at least one kind of strictures such as arc concave, V-groove structure, arc-trench structure, pyramid-like structure prism-like structure, or cone-like structure.

6. The light guide plate of claim 1, wherein the surface of the light guide patterns is at least one kind of structures, such as rough surface, flat surface, V-groove, arc-trench, pyramid-like structure, prism-like structure, cone-like structure, or cylinder-like structure.

7. The light guide plate of claim 7, wherein the auxiliary light guide structure is one kind of structures such as arc-trench or cylinder-like structure, and the dihedral angle between the tangent plane of the arc-trench or cylinder-like structure and the reference plane is less than 40 degrees.

8. The light guide plate of claim 1, wherein the dihedral angle between the auxiliary light guide surfaces of the auxiliary light guide structures and the reference plane is less than 20 degrees.

9. The light guide plate of claim 1, wherein the dihedral angle between the auxiliary light guide surfaces of the auxiliary light guide structures and the reference plane ranges between 20 and 40 degrees.

10. The light guide plate of claim 1, wherein the auxiliary light guide structures and the light guide patterns are formed on the bottom surface of the light guide plate.

11. The light guide plate of claim 1, wherein the auxiliary light guide structures and the light guide patterns are formed on the top surface of the light guide plate and the bottom surface has the second light guide patterns.

12. The light guide plate of claim 11, wherein the second light guide patterns include at least one kind of structures such as rough surface, flat surface, V-groove, arc-trench, pyramid-like structure, prism-like structure, cone-like structure, and cylinder-like structure.

13. The light guide plate of claim 1, wherein the auxiliary light guide structures and the light guide patterns are formed on the bottom surface of the light guide plate and the top surface of the light guide plate has the second light guide patterns.

14. The light guide plate of claim 13, wherein the second light guide patterns include at least one kind of structures such as V-groove, arc-trench, pyramid-like structure, prism-like structure, cone-like structure, and cylinder-like structure.
